(19) United States
(12) Patent Application Publication
(10) Pub. No.: US 2025/0287237 A1
(43) Pub. Date: Sep. 11, 2025

(54) BEAM FAILURE RECOVERY ASSOCIATED WITH HIGH FREQUENCY COMMUNICATIONS

(71) Applicant: InterDigital Patent Holdings, Inc., Wilmington, DE (US)

(72) Inventors: Prasanna Herath, Laval (CA); Young Woo Kwak, Woodbury, NY (US); Paul Marinier, Brossard (CA); Moon-il Lee, Melville, NY (US); Nazli Khan Beigi, Longueuil (CA); Haseeb Ur Rehman, Winnipeg (CA)

(73) Assignee: InterDigital Patent Holdings, Inc., Wilmington, DE (US)

(21) Appl. No.: 18/859,065

(22) PCT Filed: Apr. 26, 2023
(86) PCT No.: PCT/US2023/020015

§ 371 Date: Oct. 22, 2024

Related U.S. Application Data
(60) Provisional application No. 63/334,968, filed on Apr. 26, 2022.

(51) Int. Cl. H04W 24/08

(52) U.S. Cl. CPC H04W 24/08

(57) ABSTRACT

Systems, methods, and instrumentalities are described herein for beam failure recovery associated with high frequency communications. A wireless transmit receive unit (WTRU) may receive configuration information for candidate beam reference signals (RSs) of a first type or a second type. Upon detecting a beam failure. the WTRU may determine a beam failure recovery type (e.g., a one-step beam failure recovery or a two-step beam failure recovery), and select and transmit a first type candidate beam RS to the network. The WTRU may measure a subset of second type candidate beam RSs (e.g., associated with the first type candidate beam RS). Based on the measurement. the WTRU may select and transmit a second type candidate beam RS from the subset of second type candidate beam RSs to the network.

### CROSS-REFERENCE TO RELATED APPLICATIONS

This application claims the benefit of provisional U.S. patent application No. 63/334,968, filed Apr. 26, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for beam failure recovery associated with high frequency communications. A wireless transmit receive unit (WTRU) may be configured to receive configuration information indicating candidate beam reference signals (RSs) of a first type and candidate beam RSs of a second type. The WTRU may detect a beam failure and determine a beam failure recovery (BFR) type. If the determined BFR type is a two-step BFR type, the WTRU may select a candidate beam RS from the candidate beam RSs of the first type and transmit an indication of the selected candidate beam RS to a network. The WTRU may also determine a subset of the second type candidate beam RSs associated with the selected candidate beam RS and perform measurements of the subset of the second type candidate beam RSs during a first monitoring window. Based on the measurements, the WTRU may select a second type candidate beam RS from the subset and transmit an indication of the selected second type candidate beam RS to the network.

The candidate beam reference signals of the first type may be associated with wide beams, and the candidate beam reference signals of the second type may be associated with narrow beams. The WTRU may determine the BFR type as one of a one-step BFR type or the two-step BFR type. The subset of the second type candidate beam RSs may be determined further based on an association between the first type candidate RSs and the second type candidate beam RSs.

The BFR type may be determined based on one or more of the following: a frequency range (FR); a sub-carrier spacing (SCS); a measurement; or a configuration. Detecting a beam failure may be based on measurements of beam failure detection reference signals (BFD RSs) corresponding to the beam failure. The WTRU may determine a set of BFD parameters based on the type of BFD RSs, and the set of BFD parameters comprises one or more timers, event counters, or thresholds. The WTRU may determine a beam failure based on the parameters.

The WTRU may transmit an indication of the selected candidate beam RS using any of a Physical Random Access Channel (PRACH) preamble or resource. The WTRU may determine the subset of the second type candidate beam RSs based on a configured association with the selected candidate beam RS of the wide beam pattern or by an indication received in a PDCCH transmission.

The WTRU may monitor, in a second monitoring window, for a PDCCH transmission using the selected candidate beam RS. The WTRU may receive the PDCCH transmission in the second monitoring window using the selected candidate beam RS, and the PDCCH transmission may include an indication of a confirmation. The WTRU may transmit an indication of the selected second type candidate beam RS using a PRACH transmission.

The WTRU may receive configuration information for beam failure recovery reference signal (BFR-RS) sets, and each BFR-RS set may include resources and configurations associated with a beam failure recovery. The WTRU may select one or more BFR-RS sets for beam failure recovery based on any of a priority or a beam quality measurement, and a second type candidate beam RS may be determined using a highest priority BFR-RS from the selected one or more BFR-RS sets or by attempting to determine a new candidate beam using each selected BFR-RS set sequentially based on a priority.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of hierarchical beamforming with a gNB.

FIG. 3 illustrates an example of hierarchical beamforming with an IRS.

FIG. 4 illustrates an example of a two-step beam determination procedure (e.g., a beam determination procedure to determine a new beam).

FIG. 5 illustrates an example configuration of multiple BFR RS sets for new beam determination.

FIG. 6 illustrates an example involving single-step and two-step beam failure recovery.

### EXAMPLE NETWORKS FOR IMPLEMENTATION OF THE EMBODIMENTS

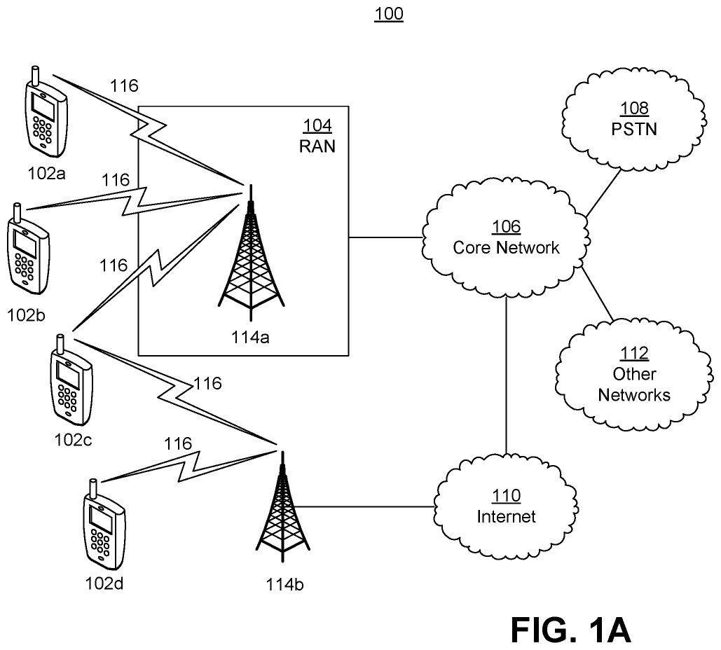

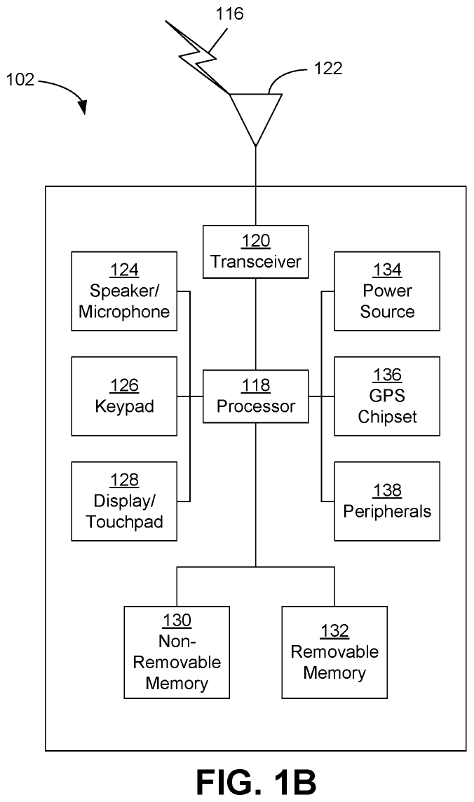

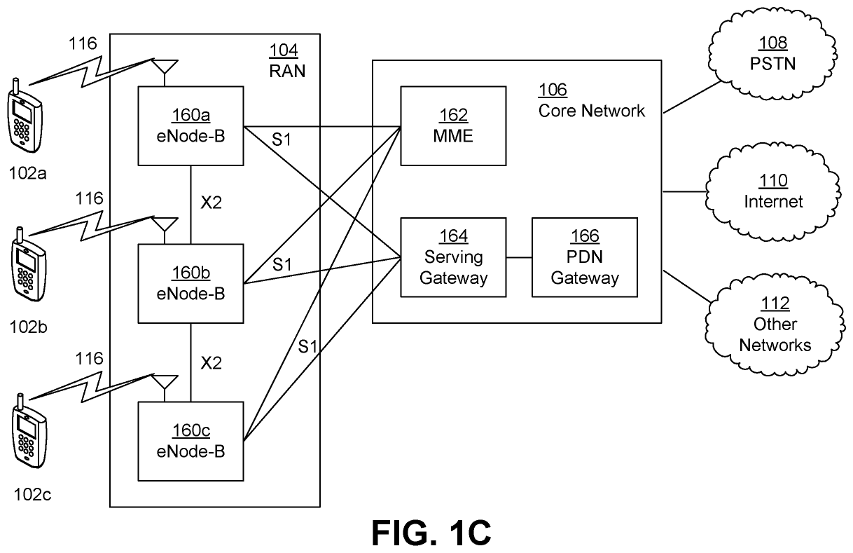

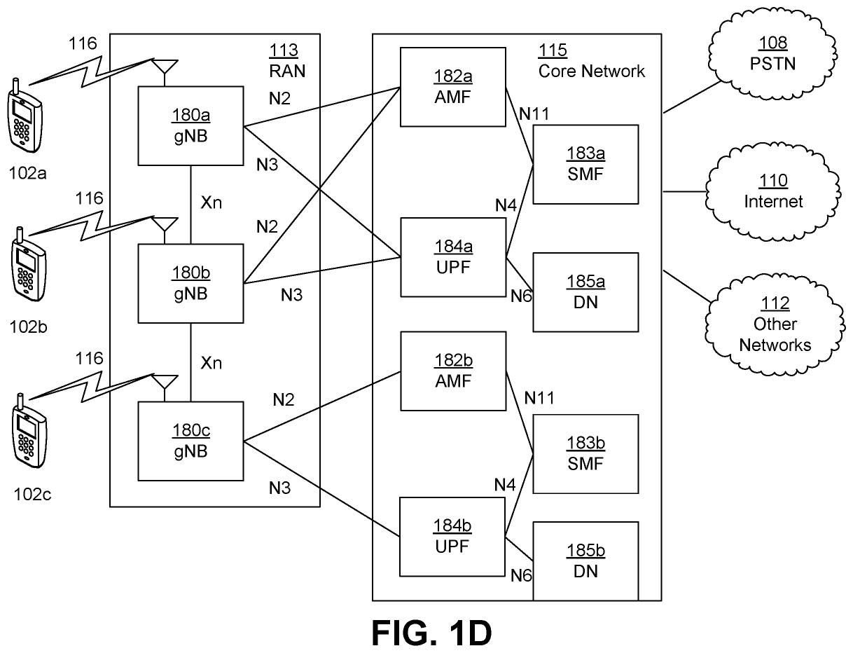

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHZ. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Beam failure recovery may be implemented through hierarchical beamforming in higher frequency communications. Higher frequency communications may be subject to path loss. Antenna gains may be increased, for example, to compensate for path loss (e.g., high path loss). Antenna gains (e.g., increasing antenna gains) may result in (e.g., highly) directive narrow beams and/or may locate network nodes (e.g., gNBs, access points, relays, IRSs, etc.) that are close to users. Beam failure recovery (e.g., in such networks) may be challenging, for example, if a small movement/rotation of a WTRU or object blocking radio wave propagation can make multiple candidate beams unsuitable for beam failure recovery. Candidate beams may be monitored to find a suitable beam pair in a beam failure, for example, to avoid frequent radio link failure (RLF). Monitoring a large number of candidate beams may degrade a throughput, for example, if beam monitoring is performed in a time-division multiplexing (TDM) fashion, which may lead to excessive overhead of time/frequency resources. Monitoring (e.g., many) candidate beams may increase power consumption by a WTRU.

A WTRU may support beam failure recovery in high frequency communications with (e.g., limited) overhead and/or with power efficiency, for example, based on one or more of the following: a beam failure indication by a WTRU; a multi-step (e.g., two-step) candidate beam determination; a WTRU determination of whether to use a single-step beam failure recovery procedure or a multi-step (e.g., two-step) beam failure recovery procedure; and/or determining one or more (e.g., monitored) BFR-RS sets to perform beam failure recovery.

A beam failure recovery may be supported by a beam failure indication by a WTRU. A WTRU may transmit a UL signal (e.g., one or more of a SRS, PRACH(s), PUCCH and/or PUSCH (MAC-CE)), which may indicate a beam failure and the determined best candidate beams. In examples, a WTRU may perform a preamble transmission with maximum power in one or more UL resources associated with the determined candidate beams. In examples, a WTRU may perform a preamble transmission with a power ramp up operation in one or more UL resources associated with the determined (e.g., best) candidate beams. In examples, a WTRU may perform a preamble repetition for better coverage in one or more UL resources associated with the determined (e.g., best) candidate beams. A WTRU may (e.g., simultaneously or concurrently) indicate a first type of candidate beam and a second type of candidate beam. In examples, the WTRU may recover a beam based on a first type of BFR operation if the WTRU reports one or more first type of beams. In examples, the WTRU may recover a beam based on a second type of BFR operation if the WTRU reports one or more second type of beams. The first type of candidate beams for beam failure recovery may be (e.g., dynamically) updated, for example, based on one or more of the following: beam failure detection resources configured for the WTRU (e.g., the first type of beams corresponds to second type of beams in failureDetectionResources); configured TCI states for PDSCH or PDCCH reception (e.g., first type of beams corresponds to RSs quasi co-location (QCL) Type-D with PDSCH DM-RS or PDCCH DM-RS); and/or activated TCI states for PDSCH reception (e.g., first type of beams corresponds to RSs QCL Type-D with PDSCH DM-RS or PDCCH DM-RS).

Beam failure recovery may be supported via a multi-step (e.g., two-step) candidate beam determination. A WTRU may receive one or more RSs for the second type of candidate beams based on one or more reported (e.g., best) first type of beams. In examples, the WTRU may receive a confirmation PDCCH (e.g., a compact PDCCH indicating RS resources/resource sets for beam sweeping of second type of candidate beams), e.g., using a configured CORESET. A WTRU-specific confirmation may include, for example, WTRU-specific PDCCH configurations and/or formats, cyclic redundancy check (CRC) scrambling with a WTRU-specific radio network identifier (RNTI), e.g., a cell RNTI (C-RNTI), etc. The WTRU may receive a second type of candidate beams associated with the reported (e.g., best) first type of candidate beams. The WTRU may monitor the second type of candidate beams, for example, based on a monitoring window and/or a counter. The second type of candidate beams may be detected, for example, using a reference signal received power (RSRP)-based and/or an energy detection-based second type of candidate beam detection. In an example of RSRP based second type of candidate beam detection, the WTRU may (e.g., expect to) receive second type of beams with a higher RSRP compared to a first type of candidate beam used for beam failure indication. In an example of energy detection-based second type of candidate beam detection, the WTRU may determine whether the WTRU received the second type of candidate beams. The WTRU may determine a second type of candidate beams, for example, based on beam measurements. The WTRU may, for example, report one or more (e.g., best) second type of candidate beam indexes. The WTRU may receive a PDCCH transmission confirming candidate beam selection, e.g., via a BFR CORESET. Transmission (e.g., Tx) power may be ramped up, for example, to re-transmit the preamble, e.g., if the PDCCH transmission is not received, e.g., via a BFR CORESET.

A WTRU may determine whether to use a single-step (first type of BFR or type 1 BFR) beam failure recovery procedure or a multi-step (e.g., two-step, second type of BFR, or type 2 BFR) beam failure recovery procedure. In examples, a WTRU may receive an explicit or an implicit indication (e.g., from a gNB) about a beam failure recovery procedure. An implicit indication may be based on, for example, one or more of the following: an aggregation level, a CORESET pool index, a CORESET duration, a CCE-to-REG mapping type, a REG bundling size, an interleave size of BFR CORESET, etc. A WTRU may determine whether to use a single-step beam failure recovery procedure or a two-step beam failure recovery procedure, for example, based on one or more of following: a number of BFRs during a time interval; a number of beam failure instances during a time interval; the expiry of a counter/timer (e.g., the WTRU may switch to a two-step beam failure recover procedure if BFR fails to provide a new candidate beam (e.g., identified beam out of candidate beams for a WTRU via BFR) during a predetermined time duration); a subcarrier spacing/frequency range; the WTRU's remaining power (e.g., if the remaining power is indicated to the gNB, for example, BFR may be performed using single-step BFR and monitor a large number of beams if the WTRU has battery power left); beamwidth supported by IRS/relays/access point/gNBs for data and control channels; or mobility of the WTRU (e.g., a fast moving WTRU may determine to use a two-step new beam determination procedure).

In examples, a WTRU may be configured with more than one BFR-RS set. A BFR-RS set may be associated with a (e.g., one) network node (e.g., IRS, relay, access point, gNB). A BFR-RS set may include resources and configurations that may be used to independently process a beam failure recovery for a WTRU. A BFR-RS set may include, for example, one or more of the following: a set of beam failure detection resources; a set of first type candidate beams resources; a set of second type of candidate beam resources; a set of UL resources (e.g., preamble etc.); a CORESET for compact PDCCH transmission; and/or a BFR CORESET.

A WTRU may select a subset of BFR-RS sets to be actively monitored (e.g., a WTRU may monitor resources that may be used for beam failure recovery of activated BFR-RS sets). In examples, a WTRU may select one or more BFR-RS sets as activated sets, e.g., based on beam measurements. A WTRU may monitor an RS resource set, which may include a first type of beam resources configured as first type of candidate beams of a set of configured BFR-RS sets. A WTRU may select a subset of configured BFR-RS sets to be actively monitored, for example, based on the quality of the (e.g., best) first type of candidate beam of BFR-RS set, e.g., subject to a preconfigured threshold. A WTRU may activate monitoring a subset of BFR-RS sets, for example, based on a DCI and or a MAC-CE indication.

An activated BFR-RS set for a WTRU may be assigned a priority. A WTRU may determine the priority of a BFR-RS set, for example, based on beam quality measurements of the first type of candidate beams associated with the active BFR-RS sets and/or based on a MAC-CE indication and/or DCI indication. In examples, a WTRU may perform a beam quality measurement of first type of candidate beams of a BFR-RS set. The WTRU may determine the beam quality of the (e.g., best) first type of candidate beam of a BFR-RS set. The WTRU may assign the priority, for example, based on the (e.g., best) first type of candidate beam. A WTRU may assign priority for activated BFR-RS sets, for example, based on the number of the first type of candidate beams that exceeds a preconfigured threshold. A WTRU may determine the priority of a BFR-RS set, for example, based on MAC-CE indication and/or DCI indication.

A WTRU may determine one or more BFR-RS sets to perform beam failure recovery. In examples, a WTRU may perform beam failure recovery with the highest priority active BFR-RS set. A WTRU may perform a beam failure recovery procedure in a sequential manner, for example, based on a priority of activated BFR-RS set. In examples, a WTRU may determine a new second type of beam via a highest priority BFR-RS set. The WTRU may use the BFR-RS set next in the priority order, for example, if the first attempt to determine a new second type of beam fails.

A PCell beam failure recovery procedure may be implemented. In an example of a beam failure recovery (BFR) procedure, a WTRU may (e.g., continuously) monitor a set of WTRU-specific periodic reference signals (RSs) (e.g., a synchronization signal block (SSB) and/or a channel state information-reference signal (CSI-RS)) associated with the beams used for physical downlink control channel (PDCCH) transmission. A WTRU may be provided (e.g., for a bandwidth part (BWP) of a serving cell) a set of periodic CSI-RS resource configuration indexes and/or synchronization signal (SS)/PBCH block indexes (e.g., set q̅₀) by failureDetectionResources. The WTRU may perform beam monitoring based on the RSS set indicated by the activated TCI-State for PDCCH reception, for example, if RSs are not provided for the purpose of beam failure detection. The set q̅₀ may include an RS index with a QCL-TypeD configuration for the corresponding TCI states, for example, if there are multiple (e.g., two) RSs in a TCI state. The WTRU may declare a beam failure and initiate a beam failure recovery procedure to identify a candidate beam (e.g., subject to a timer, such as beamFailureRecoveryTimer), for example, if the measured beam quality of a WTRU-specific periodic RS set q̅₀ becomes lower than a threshold a configured number of times (e.g., beamFailureInstanceMaxCount) within a predetermined time interval (e.g., beamFailureDetectionTimer).

Candidate beams may be selected from a set of WTRU-specific periodic RSs (e.g., SSB and/or CSI-RS) q̅₁ configured by candidateBeamRSList in an RRC configuration. A WTRU may (e.g., after finding a new beam) transmit a beam recovery request and beam failure indication (e.g., to the gNB), for example, via a dedicated physical random access response channel (PRACH). The gNB may determine the candidate beam, for example, based on an association between PRACH resources and a (e.g., periodic) CSI-RS configuration index and/or SS/PBCH block indexes. The WTRU may receive a recovery response from the gNB (e.g., after receiving the PRACH). In examples, the WTRU may be provided a dedicated CORESET through a link to a search space set (e.g., provided by recoverySearchSpaceId in an RRC configuration) for monitoring PDCCH in the CORESET. The UE may receive a PDCCH through the CORESET from the gNB, for example, to confirm the new beam selection. The beam recovery procedure may be successful (e.g., and a new beam pair link may be established), for example, if the response (e.g., from the gNB) is successfully received by the WTRU. The WTRU may perform additional beam recovery requests, e.g., by ramping up the transmit power of PRACH transmission, for example, if the WTRU did not successfully receive the response from the gNB. The WTRU may initiate contention-based RACH procedure, which may include cell re-selection, for example, if additional beam recovery requests fail to elicit a successfully received response from the gNB.

A beam failure recovery procedure may be efficient and suitable for higher frequency communications. A beam determining process may be multiple (e.g., two) steps. In examples, a wide (e.g., wider) candidate beam may be determined (e.g., in a first step). A narrow (e.g., narrower) candidate beam may be determined for a WTRU (e.g., in a second step), for example, by using a configured hierarchical relationship between wider and narrower candidate beams.

Higher carrier frequencies, such as FR2-2, may have a higher path loss, which may be compensated by having higher antenna gains, e.g., with narrow beams. Beam failure recovery with narrow beams may be challenging given that a small movement of the WTRU may render several candidate beams unsuitable for beam failure recovery. Beam failure recovery issues may be compounded by the use of network equipment located close to WTRUs and/or at lower elevations. Network equipment may include, for example, access points, indoor base stations, relays, intelligent reflection surfaces (IRS), etc. In an example of a BFR procedure, a large number of candidate beams may be monitored by a WTRU, for example, to avoid (e.g., frequent) radio link failure due to beam failure. Monitoring a large number of candidate beams may degrade the throughput and increase power consumption of the WTRU. A reduction in the number of candidate beams to be monitored may maintain or increase throughput and/or reduce power consumption. Network densification may lead to network equipment being proximate (e.g., located close) to a WTRU. A WTRU may use network equipment proximate to the WTRU to recover from a beam failure. Beam failure recovery procedures designed for higher carrier frequencies may work with one or more network devices (e.g., equipment).

Beam failure recovery for higher frequency communications may be implemented using one or more procedures.

In an example procedure for beam failure recovery for higher frequency communications, a WTRU may be configured with a first type of candidate beams for beam failure recovery and a second type of candidate beams for beam failure recovery. A WTRU may monitor and detect beam failures using the first type and/or the second type of candidate beams.

In an example procedure for beam failure recovery for higher frequency communications, a WTRU may perform a beam failure indication with a first type of beam failure indication resources and a second type of beam failure indication resources.

In an example procedure for beam failure recovery for higher frequency communications, a WTRU may determine the beam failure recovery procedure. The WTRU may (e.g., dynamically) adapt (e.g., based on the determination), for example, by switching between the first type of beam failure recovery procedure and the second type of beam failure recovery procedure.

In an example procedure for beam failure recovery for higher frequency communications, a WTRU may perform beam failure recovery based on a second type of beam failure recovery procedure with multiple (e.g., two) types of candidate beams.

In an example procedure for beam failure recovery for higher frequency communications, a WTRU may perform a second type of beam failure recovery procedure with multiple beam failure recovery resource sets.

A WTRU may transmit or receive a physical channel or reference signal according to at least one spatial domain filter. The term “beam” may (e.g., be used to) refer to a spatial domain filter.

A WTRU may transmit a physical channel or signal using the same spatial domain filter as the spatial domain filter used for receiving an RS (e.g., CSI-RS) or an SS block. A WTRU transmission may be referred to as a “target.” A received RS or SS block may be referred to as a “reference” or “source.” A WTRU may (e.g., in this case) transmit the target physical channel or signal according to a spatial relation with a reference to an RS or SS block.

A WTRU may transmit a first physical channel or signal according to the same spatial domain filter as the spatial domain filter used for transmitting a second physical channel or signal. The first and second transmissions may be referred to as a target and/or reference (e.g., a source), respectively. A WTRU may be said to transmit the first (e.g., target) physical channel or signal according to a spatial relation with a reference to the second (e.g., reference) physical channel or signal.

A spatial relation may be, for example, implicit, configured by RRC, or signaled by MAC-CE or DCI. In examples, a WTRU may (e.g., implicitly) transmit PUSCH and a demodulation reference signal (DM-RS) of PUSCH according to the same spatial domain filter as an SRS indicated by an SRS resource indicator (SRI) indicated in DCI or configured by RRC. A spatial relation may be configured by RRC for an SRI or signaled by a MAC-CE for a PUCCH. A spatial relation may (e.g., also) be referred to as a “beam indication.”

A WTRU may receive a first (e.g., target) downlink channel or signal according to the same spatial domain filter or spatial reception parameter as a second (e.g., reference) downlink channel or signal. In examples, an association may exist between a physical channel (e.g., PDCCH or PDSCH) and the physical channel's respective DM-RS. An association may exist (e.g., at least if the first and second signals are reference signals), for example, if the WTRU is configured with a quasi-colocation (QCL) assumption type D between corresponding antenna ports. An association may be configured as a transmission configuration indicator (TCI) state. An association between a CSI-RS or SS block and a DM-RS may be indicated to a WTRU, for example, by an index to a set of TCI states configured by RRC and/or signaled by MAC-CE. An indication may (e.g., also) be referred to as a “beam indication.”

Beam failures may be monitored for and detected.

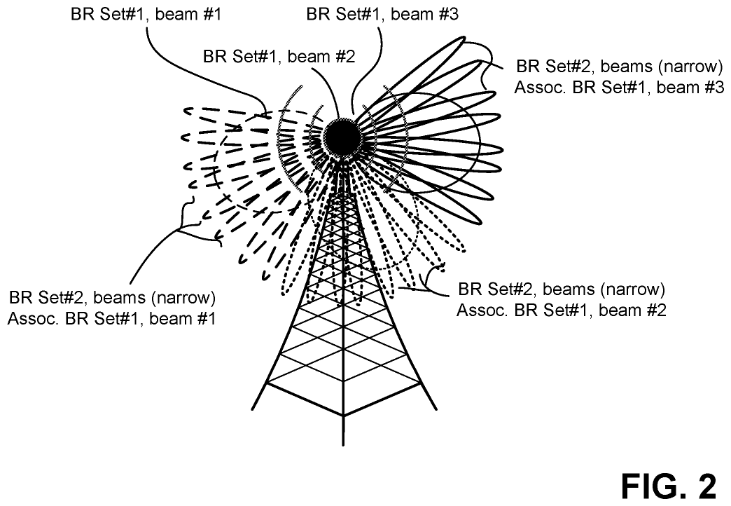

FIG. 2 illustrates an example of hierarchical beamforming with a gNB.

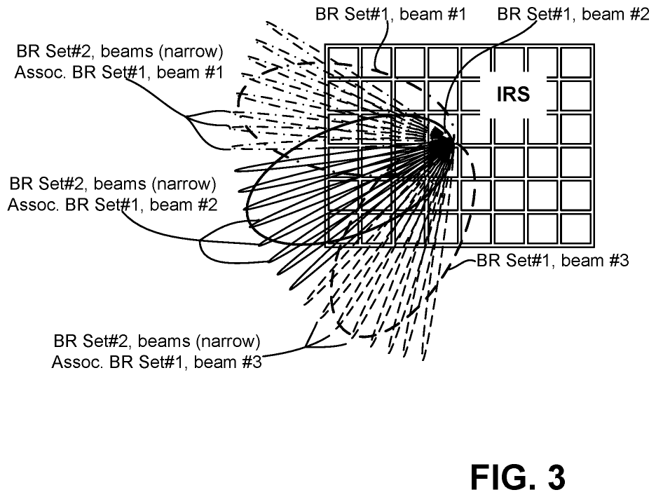

FIG. 3 illustrates an example of hierarchical beamforming with an IRS.

Beam, as described herein, may be used interchangeably with one or more of the following: a reference signal; a sounding reference signal (SRS); a channel state information-reference signal (CSI-RS); a demodulation reference signal (DM-RS); a phase tracking reference signal (PT-RS); a synchronization signal block (SSB); etc.

Channel, as described herein, may be used interchangeably with one or more of following: a PDCCH; a PDSCH; a physical uplink control channel (PUCCH); a physical uplink shared channel (PUSCH); a physical random access channel (PRACH); etc.

CSI reporting, as described herein, may be used interchangeably with one or more of the following: CSI measurement, beam reporting, and beam measurement, etc.

Quality, as described herein, may be used interchangeably with one or more of the following: reference signal received power (RSRP), reference signal received quality (RSRQ), signal to interference and noise ratio (SINR), channel quality indicator (CQI), modulation and coding scheme (MCS), hypothetical PDCCH block error rate (BLER), etc.

A configuration may be provided for beam failure recovery (BFR).

In an example of a BFR configuration, a WTRU may be configured with one or more sets of beam failure detection (BFD) RSs (e.g., q̅₀ or q̅_{0,i} for example, if the WTRU is configured with two or more sets of BFD RSs). The set q̅_{0,i} may be the set of beam failure detection RSs associated with i^{th} link.

In examples, multiple links may be configured for a mode of operation. A first set of BFD-RS (e.g., q̅_{0,1}) may be associated with a first link (e.g., a direct link) and a second set of BFD-RS (e.g., q̅_{0,2}) may be associated with a second link (e.g., reconfigurable intelligent surface (RIS) link).

A configuration of one or more sets of BFD-RS may be based on an implicit configuration. A WTRU may determine one or more sets of BFD-RSs based on one or more RSs (e.g., RSs with QCL Type-D in configured TCI states for PDCCH reception), for example, if the WTRU does not receive explicit configuration of the one or more sets of BFD-RS.

In examples, the WTRU may determine one or more BFD-RS sets based on an explicit/implicit CORESET/search space group configuration/indication. The CORESET/search space group configuration/indication may be based on one or more of following: link ID/type of CORESETs; CORESET/search space type; and/or ID configuration (e.g., CORESET/search space ID and/or TCI state ID).

In an example of a CORESET/search space group configuration/indication based on a link ID/type of CORESETs, a WTRU may be configured with one or more CORESETs with a link ID and/or a link type. The WTRU may determine a CORESET group for the one or more CORESETs, for example, based on the link ID and/or link type. The WTRU may receive a link ID in a TCI state configuration, for example, (e.g., instead of a CORESET configuration). The WTRU may determine, for example, that RSs associated with a first link ID and/or link type (e.g., first link or first RS type) are a first BFD-RS set and RSs associated with a second link ID and/or link type (e.g., second link or second RS type) are a second BFD-RS set.

In an example of a CORESET/search space group configuration/indication based on an ID configuration (e.g., CORESET/search space ID and/or TCI state ID), a WTRU may determine the CORESET group based on an ID. The WTRU may determine an RS associated with a first CORESET as a first BFD-RS set, for example, based on a comparison of an associated ID of the first CORESET to a threshold, such as if the associated ID of the first CORESET is smaller than (e.g., or equal to) the threshold. The WTRU may determine an RS associated with the first CORESET as a second BFD-RS set, for example, based on a comparison of an associated ID of the first CORESET to a threshold, such as if the associated ID of the first CORESET is larger than the threshold.

In an example of a BFR configuration, a WTRU may be configured with one or more sets of candidate beam (CB) RSs (e.g., q̅₁ or q̅_{1,i} where q̅_{1,i} may be the set of CB RSs associated with an i^{th} link). In examples, multiple links may be configured for a mode of operation. The first set of CB-RS (e.g., q̅_{1,1}) may be associated with a first link (e.g., direct link), and the second set of CB-RS (e.g., q̅_{1,2}) may be associated with a second link (e.g., RIS link). A CB-RS in the set may be associated with one or more uplink resources (e.g., PRACH, PUCCH, PUSCH, and/or SRS).

In an example of a BFR configuration, a WTRU may be configured with one or more sets of uplink resources (e.g., S or Sᵢ, where Sᵢ may be an uplink resource associated with an i^{th} link) for a new candidate beam indication. In examples, multiple links may be configured for a mode of operation. The first uplink resource (e.g., S₁) may be associated with a first link (e.g., direct link) and the second uplink resource (e.g., S₂) may be associated with a second link (e.g., RIS link). Uplink resources may be one or more of the following: PRACH resources, PUCCH resources (e.g., for scheduling request), RS resources (e.g., SRS resources), etc.

In an example of a BFR configuration, a WTRU may be configured with one or more sets of search spaces (e.g., C or Cᵢ, where Cᵢ may be an uplink resource associated with an i^{th} link) for receiving one or more confirmations of the BFR. In examples, multiple links may be configured for a mode of operation. The search space (e.g., C₁) may be associated with a first link (e.g., direct link) and the second search space (e.g., C₂) may be associated with a second link (e.g., RIS link).

Hierarchical beamforming may support beam failure recovery.

Beam failure recovery for a WTRU may be supported, for example, by using an association between different types of beam resources. A beam resource may include, for example, a CSI-RS, an SSB, TCI state, and/or the like. A beam resource (BR) may be identified, for example, by an ID (e.g., CSI-RS resource ID, SSB index, TCI state ID).

In examples, a WTRU may be configured with one or more first type of beam resource sets and second type of beam resource sets. FIGS. 2 and 3 show example configurations. As shown by example in FIGS. 2 and 3, BR set #1 and BR set #2 may represent a first type of beam resource sets and a second type of beam resource sets, respectively. A beam resource of BR set #2 may be associated with at least one beam resource of BR set #1. One or more beam resources of BR set #2 may be associated with the same beam resource of BR set #1. The beam resources of BR set #1 and BR set #2 may be characterized by different beamwidths. Each beam of the BS set #1 with large beamwidth may be associated with one or more beam resources of BS set #2 with narrow beamwidth, for example, as illustrated in FIGS. 2 and 3. Beam resources of BR set #1 may be in the same or different frequency range (e.g., lower frequency range) compared to associated beam resources of BR set #2.

Beam resources of a first type (e.g., a wide beam pattern) may be used interchangeably with a first type of beams and/or first beams. Beam resources of a second type (e.g., a narrow beam pattern) may be used interchangeably with a second type of beams and/or second beams.

An association may be created (e.g., established) between the first beams and second beams.

A WTRU may be configured with one or more first type of beams (e.g., first beams) and one or more second type of beams (e.g., second beams). The WTRU may determine a type of beams, for example, based on one or more of following: a gNB indication/configuration; a TCI state ID/CSI-RS ID/SSB ID grouping/partitioning; a frequency range; a configured network node; a sub-carrier spacing (SCS); etc.

In an example of a WTRU determining a type of beams based on a gNB indication/configuration, the WTRU may receive an indication and/or a configuration that indicates a type of beam (e.g., based on one or more of RRC, MAC-CE and DCI).

In an example of a WTRU determining a type of beams based on a TCI state ID/CSI-RS ID/SSB ID grouping/partitioning, TCI states and/or CSI-RSs may be grouped or partitioned. The type of beam may be indicated, for example, as a property of the group or the partition. In examples, the WTRU may receive an indication and/or a configuration that indicates that a non-zero powered (NZP)-CSI-RS-ResourceSet has the property of a first type or a second type. In examples, a WTRU may be configured with N number of TCI states. The WTRU may receive an indication and/or configuration that partitions N number of TCI states into M partitions (e.g., a partition may be indicated by N bits, where a bit may correspond to a TCI state the WTRU is configured with, and where a bit set to ‘1’ may indicate a particular TCI state that belongs to the partition). The WTRU may receive an indication and/or configuration that indicates the type of beams as a property of a partition.

In an example of a WTRU determining a type of beams based on a frequency range, the WTRU may determine a type of beam based on the frequency range a beam is associated with. In examples, beams with carrier frequency of FR2-1 may be a first type of beams and beams with carrier frequencies of FR2-2 may be a second type of beams.

In an example of a WTRU determining a type of beams based on a configured network node, the WTRU may determine the type of beam based on the network node that a beam and/or set of beams is/are associated with. In examples, a first beam may be a beam received (e.g., directly) from a gNB and a second beam may be a beam received through a reconfigurable intelligent surface (RIS).

In an example of a WTRU determining a type of beams based on an SCS, a beam/set of beams received/configured to be received with (e.g., specific) SCSs may be determined to be the first beams or the second beams.

A first beam may be associated with one or more second beams.

In an example of a first beam being associated with one or more second beams, a first beam may be associated with a set of second beams based on one or more of following: a configuration of a first beam ID; configuration of a first beam ID for a set of second beams; etc. In an example of a first beam being associated with a set of second beams based on a configuration of a first beam ID, the WTRU may receive an indication and/or a configuration of a first beam ID for a second beam.

In an example of a first beam being associated with one or more second beams, a WTRU may receive an indication and/or a configuration of a first beam ID for a set of second beams identified by an ID. In examples, a WTRU may receive an indication and/or a configuration that indicates an NZP-CSI-RS-ResourceSet of second type beams is associated with a specific first beam. In examples, a WTRU may receive an indication and/or a configuration that indicates a group/partition of TCI states that WTRU is configured with are second type beams and indicates that the group/partition is associated with a specific first beam.

A WTRU may perform beam failure detection, where one or more of the following may apply/be performed.

A WTRU may be configured with one or more BFD-RSs. A WTRU may be configured with one or more of the following beam failure detection (BFD) parameters for a type of beams (e.g., first beams and second beams): beamFailureDetectionTimer, beamFailureInstanceMaxCount, threshold, etc.

A beam failure detection time (e.g., beamFailureDetectionTimer) may indicate, for example, a maximum (e.g., max) duration that the WTRU may take for a beam failure detection before a beam failure instance (BFI) counter is reset.

A beam failure instance threshold (e.g., beamFailureInstanceMaxCount) may indicate, for example, the number of BFIs the WTRU may count before the beamFailureDetectionTimer expires to detect a beam failure.

A threshold may indicate when to increment the number of beam failure instances. In examples, the WTRU may detect and increment the number of beam failure instances if/when measured qualities of all or a part of BFD-RSs are less than Threshold.

A WTRU may be configured with the same or different values for BFD parameters associated with different beam types. In examples, a WTRU may be configured with one or more first values (e.g., relatively smaller values) of beamFailureInstanceMaxCount and beamFailureDetectionTimer for the BFD-RSs associated with a second type of beams. In examples, a WTRU may be configured with a (e.g., high) threshold for the BFD-RS associated with a first type of beam(s).

A WTRU may be configured with a quantized value of a BFD parameter for one or more types of beams and/or a parameter offset for a BFD parameter associated with other types of beams. In examples, a WTRU may be configured with a value of beam quality threshold for a second type of beam and/or a offset beam quality (e.g., Threshold_Offset) for the first type of beam. The WTRU may calculate a threshold for a first type of beam, for example, based on (e.g., from) the configured quality threshold of the second type of beam and the offset (e.g, Threshold_Offset).

A WTRU may measure a quality of a BFD-RS.

A WTRU may determine (e.g., declare) a BFI, for example, based on a measured quality of the BFD-RS and (e.g., compared to) the configured threshold.

A WTRU may associate a BFI to a particular BFD-RS. In examples, a WTRU may associate a BFI to a first type of beams, a second type of beams, and/or the first and second type of beams, for example, based on the BFD-RS on which the WTRU may detect a BFI (e.g., after measuring beam quality).

A WTRU may use a variable (e.g., BFI_COUNTER) to count the number of beam failure instances, which may be initially set to zero. The variable (e.g., BFI_COUNTER) may be BFD-RS specific. In examples, a WTRU may initialize and/or monitor (e.g., keep track of) one or more BFI_COUNTERs (e.g., BFI_COUNTER_RS1, BFI_COUNTER_RS2, etc.).

A WTRU may detect a beam failure on a particular BFD-RS, for example, if/when the associated BFI_COUNTER reaches the corresponding beam failure instance threshold (e.g, beamFailureInstanceMaxCount), e.g., provided that the configured beam failure detection timer (e.g., beamFailureDetectionTimer) for the BFD-RS does not expire.

A WTRU may declare a beam-type specific beam failure, for example, depending on the BFD-RS. A WTRU may declare a beam failure on the first type of beams, the second type of beams, or the first type and second type of beams, for example, based on the BFD-RS for which the WTRU detects a beam failure.

In examples, a WTRU may determine a set of BFD parameters (e.g., one or more of beamFailureDetectionTimer (e.g., a timer), beamFailureInstanceMaxCount (e.g., an event counter), and/or a threshold) among multiple sets of BFD parameters. The WTRU may determine a set of BFD parameters based on the type of BFD RSs, and the set of BFD parameters may include timers, event counters, and/or thresholds. The WTRU may determine a beam failure based on the parameters.

The determination may be based on, for example, a type of BFD-RS. A WTRU may apply a first set of BFD parameters for beam failure detection, for example, if the WTRU detects a beam failure by measuring one or more first beams. The WTRU may apply a second set of BFD parameters for beam failure detection, for example, if the WTRU detects a beam failure by measuring one or more second beams.

In examples, a WTRU may apply a set of differential BFD parameters based on a configured set of BFD parameters. A WTRU may apply differential values, for example, if the WTRU detects a beam failure by measuring one or more first beams (or second beams). Examples of differential values may include, for example, one or more of the following: the WTRU may add/subtract A from beamFailureDetectionTimer; the WTRU may add/subtract B from beamFailureInstanceMaxCount; the WTRU may add/subtract C from a threshold; etc. One or more of A, B, and/or C may be configured/indicated, for example, by one or more of RRC, MAC-CE, and/or DCI.

In examples, a WTRU may add/subtract additional quality values (e.g., SINR, RSRP, RSRQ, PDCCH hypothetical BLER, and/or the like) from measurements, for example, if/when the WTRU detects a beam failure, e.g., by measuring one or more first beams. A WTRU may use +Y percent (%) as a determined PDCCH hypothetical BLER for beam failure detection, for example, if the WTRU determines X % of PDCCH hypothetical BLER, e.g., by measuring a first beam.

Candidate beams may be monitored for beam failure recovery.

A WTRU may be configured with one or more types of beams (e.g., CB-RSs) for candidate beam measurement and/or for new candidate beam determination. The term “beam” may be used interchangeably with beam reference signal, beam reference measurement signal, CSI-RS, SSB, and/or reference signal.

A first type of beam (e.g., first beam) may be associated with one or more second type of beams (e.g., second beam). In examples, one or more first beams may be used, configured, or determined. A first beam may be associated with a set of second beams. In an example, the first beam may be referred to as a wide beam and the second beam may be referred to as a narrow beam. A wide beam may correspond to one or more narrow beams. In examples, the first beam may be a beam received (e.g., directly) from a gNB and the second beam may be a beam received through an RIS.

In examples, a WTRU may be triggered and/or may determine to measure one or more candidate beams, e.g., based on one or more conditions that may be configured and/or predefined. The WTRU may determine to measure a subset of candidate beams within a set of candidate beams that may be determined and/or configured, for example, based on one or more following conditions: a type of beam for a BFD RS and/or a beam quality of first beams and/or second beams.

In an example of determining and/or configuring a set of candidate beams based on a type of beam for a BFD RS, one or more second beams may be configured as a BFD RS set for a WTRU. The WTRU may detect beam failure for the BFD RS set. In examples, the WTRU may perform a candidate beam measurement for (e.g., all) beams within the one or more candidate beams. In examples, the WTRU may perform candidate beam measurements (e.g., only) for one or more first beams within the one or more candidate beams. In examples, the WTRU may perform candidate beam measurements (e.g., only) for one or more second beams, which may be associated with the same first beam (e.g., previously determined, indicated, or reported) within the one or more candidate beams.

In an example of determining and/or configuring a set of candidate beams based on a beam quality of first beams and/or second beams, a WTRU may perform measurement of the first beams in the candidate beams. The WTRU may skip measurement for the second beams in the candidate beams, for example, if at least one of the first beams meets one or more (e.g., (pre) defined or (pre) configured) criteria (e.g., thresholds or other requirements). The WTRU may perform measurement of the second beams in the candidate beams, for example, if the first beams do not meet one or more (e.g., (pre) defined or (pre) configured) criteria (e.g., thresholds or other requirements).

In examples, a WTRU may perform a measurement for a subset of candidate beams. The subset may be determined, for example, based on a mode of operation. A first subset may be used or determined, for example, if the WTRU is in a first mode of operation. A second subset may be used or determined, for example, if the WTRU is in a second mode of operation. The mode of operation may include, for example, at least one of the following: an RIS assisted mode, a RIS non-assisted mode, a hierarchical beam mode, and/or a non-hierarchical beam mode. The mode of operation may be determined, for example, based on one or more of following: an (e.g., explicit) indication from a network/gNB (e.g., broadcasting via SIB, semi-static configuration via RRC and/or MAC-CE, dynamic indication via a DCI); a set of beams determined/configured for beam failure detection RS (e.g., q0); a channel condition (e.g., delay spread, beam quality, etc.); and/or a number of beams configured or used.

In examples, a WTRU may determine a set of parameters for a new beam candidate selection among multiple sets of parameters for new beam candidate selection. The determination may be based on a type of CB-RS. The WTRU may apply a first set of CB parameters for a new beam selection, for example, if the WTRU selects the new beam by measuring one or more first beams. The WTRU may apply a second set of CB parameters for a new beam selection, for example, if the WTRU selects a new beam by measuring one or more second beams.

In examples, a WTRU may add/subtract additional values from quality measurements, e.g., if the WTRU measures one or more first beams. A WTRU may use X+Y dB as a measured RSRP value for new beam selection, for example, if the WTRU measures X dB by measuring a first beam. The WTRU may use the measured value X dB for new beam selection, for example, if the WTRU does not measure X dB by measuring the first beam.

A beam failure indication may be determined, indicated, triggered, etc. by a WTRU.

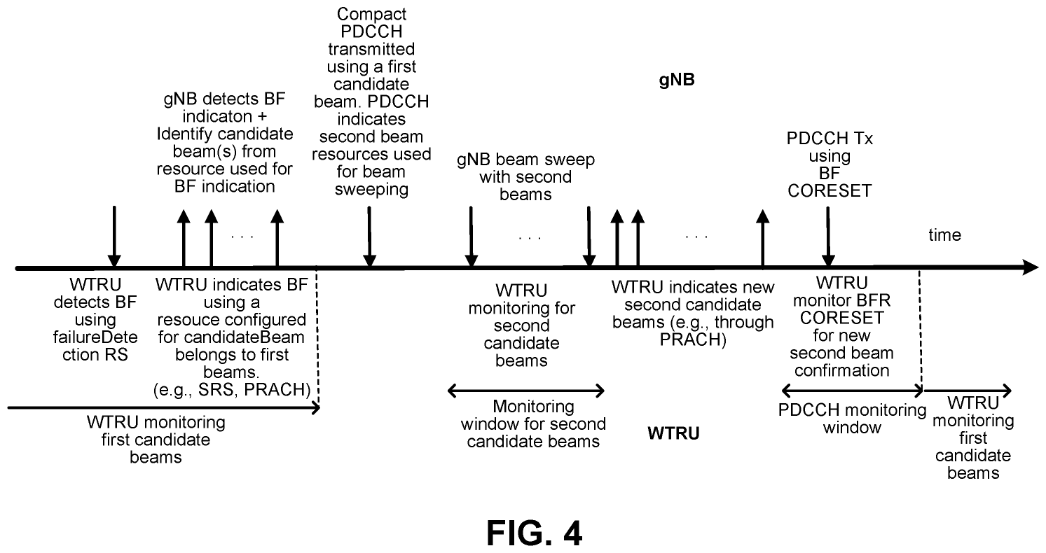

FIG. 4 illustrates an example of a two-step beam determination procedure (e.g., a beam determination procedure to determine a new beam).A WTRU may determine, indicate, or trigger a beam failure indication and/or a recovery procedure, for example, based on a beam failure detection. The WTRU may indicate, determine, or be configured, for example, with one or more of the following parameters: a BFR_Timer (e.g., a timer may start with a beam failure recovery procedure); an RSRP_Threshold (e.g., a threshold for RSRP may be used in beam failure recovery); a candidateBeamRSList (e.g., a list of candidate beam reference signal indexes that may be monitored, measured, and/or selected during the beam failure recovery); power ramping (e.g., parameters may include a power ramping step, received preamble target power, and/or the like); and/or random access (e.g., PRACH parameters may include a preamble index, an SSB per RACH occasion, a random access response window, a PRACH configuration index, a random access occasions, SSBs association mask index, and/or the like). The foregoing parameters are a non-limiting example of parameters that may be included in a beam failure indication and/or recovery. One or more parameters may be included in various implementations.

A WTRU may use, receive, and/or be configured with one or more sets of reference signals per BWP for monitoring, measuring, and/or selecting as the resources for a beam failure recovery. In examples, the term q1 may be used for the beam failure recovery set. In examples, the terms q1,0 or q1,1 may be used as the beam failure recovery sets. The beam failure recovery sets (e.g., set q1, q1,0, or q1,1) may include one or more reference signals. The reference signals may be, for example, CSI-RS resource configuration indexes and/or SS/PBCH block (SSB) indexes. In an example, the reference signals included in beam failure recovery RS sets may be based on a candidateBeamRSList, which may be configured as part of a BFR procedure.

A WTRU may initiate a beam failure recovery, for example, based on a random-access procedure. In an example, the WTRU may configure the random-access parameters, start the BFR_Timer, and/or apply the power ramping parameters.

A WTRU may monitor and/or measure one or more reference signals from the candidateBeamRSList. The WTRU may determine whether at least one of the SSBs has an SS-RSRP above a respective RSRP_Threshold amongst the SSBs in candidateBeamRSList, and/or whether at least one of the CSI-RSs has a CSI-RSRP above a respective RSRP_Threshold amongst the CSI-RSs in candidateBeamRSList.

A WTRU may select a respective reference signal as a candidate new beam/random-access resource for BFR procedure. In examples, the term q_new may be used to present the new selected beam/random-access resource. The WTRU may perform PRACH transmission in respective random-access resources. Transmission may be performed according to a spatial relation with the periodic CSI-RS resource configuration and/or with the SS/PBCH block associated/QCL-ed with index q_new.

A WTRU may initiate a MAC-CE beam failure recovery procedure for example, if uplink channel resources (e.g., uplink shared channel resources (UL-SCH)) are available. The WTRU may generate and/or transmit the BFR MAC-CE on the respective uplink channel resources.

WTRUs may monitor, measure, select, and/or report from a large number of candidate beams at higher frequencies and/or due to narrower beam-widths, for example, to avoid frequent radio link failure due to beam failure.

In examples, a WTRU may use hierarchical beamforming for a beam failure indication and/or recovery. A WTRU may receive, identify, and/or determine that a beam failure recovery procedure is triggered and/or initiated. The WTRU may measure, estimate, and/or determine a candidate beam, for example, from a (e.g., configured) list of candidate beam reference signals (e.g., candidateBeamRSList).

In examples, a WTRU may indicate, recommend, and/or report the determined best candidate beam. In examples, a WTRU may indicate the candidate beams, for example, by transmitting uplink signal on one or more of SRS, PRACH(s), PUCCH, and/or PUSCH (MAC-CE). In an example, one or more of the following may apply: the WTRU may transmit the UL signal with maximum power in one or more UL resources associated with the determined (e.g., best) candidate beams; the WTRU may transmit the UL signal with power ramp up operation in one or more UL resources associated with the determined candidate beams; and/or the WTRU may transmit the UL signal with configured and/or determined repetition (e.g., for coverage enhancement) in one or more UL resources associated with the determined candidate beams.

A parent candidate BFR RS may be configured. In examples, a WTRU may receive, identify, and/or determine one or more candidate beam failure recovery RS lists. The beam reference signals in a first candidate BFR RS list may be associated with the beam reference signals in a second candidate BFR RS list. In examples, at least one of the beam reference signals in the first candidate BFR RS list may be referred to as parent or fallback beam. One or more beam reference signals in the second candidate BFR RS list may be associated with the same beam reference signal in the first candidate BFR RS list, which may physically correspond to a larger beam-width for the beam reference signals in the first BFR RS list and/or may physically correspond to a narrower beam-width for the beam reference signals in the second BFR RS list. The WTRU may receive or transmit (e.g., simultaneously) using a beam reference signal from the second BFR RS list and respective parent beam RS from the first BFR RS list.

In examples, a WTRU may initiate a beam failure recovery procedure by indicating one or more of the determined candidate beam reference signals from the second BFR RS list while (e.g., at the same time) indicating the associated parent candidate beam reference signal from the first BFR RS list.

A WTRU may initiate a multi-step (e.g., two-step) beam failure recovery procedure (e.g., as described herein), for example, if the WTRU reports the indication of the candidate beam RS based on one or more parent beam reference signals in the first candidate BFR RS list. The WTRU may initiate a single-step beam failure recovery procedure (e.g., as described herein) for example, if the WTRU reports the indication of the best candidate beam RS based on one or more parent beam reference signals in the first candidate BFR RS list and/or one or more of the associated beam reference signals in the second candidate BFR RS list.

A candidate BFR RS may be (e.g., dynamically) updated. In examples, a WTRU may report, recommend, refine, and/or update one or more candidate BFR RS lists. In examples, a WTRU may report and/or update the parent candidate BFR RS list. The BFR RS list may be updated, for example, based on one or more of the following: beam failure detection reference signals (BFD-RS) and/or TCI states for PDSCH/PDCCH reception.

In an example of updating a BFR RS list based on beam failure detection reference signals (BFD-RS), a WTRU may determine and/or update a parent candidate BFR RS list based on the configured BFD reference signals. In examples, the WTRU may measure, monitor, and/or identify the list of (e.g., preferred) BFD reference signals. The WTRU may determine and/or update one or more of the parent candidate BFR RSs that may be associated with the identified (e.g., preferred) BFD-RSs.

In an example of updating a BFR RS list based on TCI states for PDSCH/PDCCH reception, a WTRU may determine and/or update a parent candidate BFR RS list based on the configured TCI states for PDSCH/PDCCH reception. In examples, the WTRU may measure, assess, and/or update one or more of the parent candidate BFR RSs according to antenna port quasi co-location parameters associated with reference signals (e.g., SSB and/or CSI-RS) that may be associated with configured a downlink reception (e.g., PDSCH/PDCCH DM-RS).

A WTRU may determine a beam failure recovery procedure. A WTRU may switch between types of beam failure recovery procedures. In examples, a WTRU may determine a type of beam failure recovery procedure. In examples, the WTRU may determine a first type of beam failure recovery (BFR) procedure (e.g., a one-step beam failure recovery procedure) or a second type of BFR procedure (e.g., a two-step beam failure recovery procedure). A WTRU may determine a type of beam failure recovery procedure, for example, based on one or more of the following: an explicit/implicit indication from a gNB and/or a type of a selected resource for new candidate beams.

In an example of determining a type of beam failure recovery procedure based on an explicit/implicit indication from a gNB, a WTRU may receive an explicit or implicit indication, for example, from RRC, MAC, or DCI signaling. In examples, RRC configuration for beam failure recovery may include an indication whether to perform the second type of BFR procedure (e.g., a two-step procedure). In examples, a MAC-CE may indicate which recovery procedure to follow, e.g., along with at least one index to an associated configuration. In examples, the WTRU may receive an (e.g., implicit) indication based on one or more of the following: aggregation level, CORESET pool index, CORESET duration, CCE-to-REG mapping type, REG bundling size, interleave size of one or more BFR CORESETs, etc.

In an example, a WTRU may determine the type of beam failure recovery procedure based on the aggregation level/CORESET duration/REG bundling size/interleave size of one or more BFR CORESETs. A WTRU may choose a type (e.g., a first type or a second type) of beam failure recovery procedure, for example, if the aggregation level/CORESET duration/REG bundling size/interleave size is beyond (e.g., lower than) a preconfigured value. In examples, a WTRU may choose a type (e.g., a first type or a second type) of beam failure recovery procedure based on whether the WTRU is configured with a BFR CORESET with a pool index of 0 or 1. In a examples, a WTRU may choose a type (e.g., a first type or a second type) of beam failure recovery procedure based on whether the CCE-to-REG mapping type of one or more BFR CORESET is interleaved or non-interleaved.

In an example of determining a type of beam failure recovery procedure based on a type of a selected resource for new candidate beams, a WTRU may determine the type of procedure based on a selected resource among a set of resources configured as candidate beams (e.g., q1). In examples, a WTRU may select one or more of the set of resources for which quality (e.g., RSRP, RSRQ, SINR, CQI, and/or hypothetical PDCCH BLER) is above a (e.g., configured) threshold. A WTRU may perform the second type of BFR procedure (e.g., a two-step procedure), for example, if the WTRU selects one or more first beams as new candidate beams. A WTRU may perform the first type of BFR procedure (e.g., a one-step procedure), for example, if the WTRU selects one or more second beams as new candidate beams.

A WTRU may be configured with first and second thresholds for resources corresponding, respectively, to first beams and second beams. A WTRU may select (e.g., prioritize) a resource corresponding to a second beam, for example, if at least one resource corresponding to first beams and/or at least one resource corresponding to second beams meet the criteria. Alternatively, The WTRU may select (e.g., prioritize) a resource corresponding to a first beam. An indication whether to prioritize a resource corresponding to first or second beam may be configured by higher layers.

In examples, a WTRU may initiate a second type of BFR procedure (e.g., a two-step beam failure recovery procedure) depending on (e.g., satisfaction of) at least one of the following conditions: whether a first type or second type of beam failure recovery procedure was initiated or completed more than N times within a time interval T; whether a “procedure selection timer” is running; a measurement and/or metric related to a mobility aspect; a frequency range (FR) for the serving cell; a sub-carrier spacing (SCS) for the bandwidth part; a number of configured TCI states and/or a number of SSB's detected by the WTRU for the serving cell; a beamwidth supported by IRS/relays/access point/gNBs for data and/or control channels; and/or remaining battery power.

In an example of initiating a second type of BFR procedure depending on whether a first type or a second type of beam failure recovery procedure was initiated or completed more than N times within a time interval T, N and T may be pre-defined or configured by higher layers. The WTRU may initiate a second type of beam failure recovery procedure, for example, if/when beam failure is detected, e.g., and the condition is satisfied.

In an example of initiating a second type of BFR procedure depending on whether a “procedure selection timer” is running, a timer may be started, e.g., upon initiation or completion of a first type or a second type of beam failure recovery procedure. The WTRU may initiate a second type of beam failure recovery procedure, for example, if/when beam failure is detected, e.g., and the procedure selection timer is running. The duration of the procedure selection timer may be pre-defined or configured by higher layers.

In an example of initiating a second type of BFR procedure depending on a measurement and/or metric related to a mobility aspect, a WTRU may perform a second type of beam failure recovery procedure if the measurement and/or metric is above a pre-defined or configured threshold. The metric or measurement may include, for example, one or more of the following: a speed estimate based on positioning measurements or channel measurements; a Doppler measurement; a number N of changes of TCI states for PDCCH or PDSCH within a time interval T, where N and T may be pre-defined or configured by higher layers; and/or a number N of changes of a CRI (e.g., CSI-RS resource indicator) or an SSBRI (e.g., SSB resource indicator) within a time interval T.

In an example of initiating a second type of BFR procedure depending on a frequency range (FR) for the serving cell, the WTRU may perform a second type of procedure for FR2 or FR3.

In an example of initiating a second type of BFR procedure depending on a sub-carrier spacing (SCS) for the bandwidth part, a WTRU may perform a second type of procedure for SCS based on (e.g., larger than) a pre-defined threshold.

In an example of initiating a second type of BFR procedure depending on a number of configured TCI states or a number of SSB's detected by the WTRU for the serving cell, the WTRU may perform a second type of procedure if/when the number of configured TCI states exceeds a pre-defined or configured threshold.

In an example of initiating a second type of BFR procedure depending on remaining battery power, a WTRU may perform a second type of procedure based on remaining battery power compared to a threshold (e.g., if remaining battery power is below a threshold).

A beam failure recovery procedure may be a one-step beam failure recovery procedure. In examples, a WTRU may determine/select a first type of BFR procedure (e.g., one step beam failure recovery procedure). A WTRU may support one or more of the following procedures, e.g., for the first type of BFR procedure.

A WTRU (e.g., having determined/selected a first type of BFR procedure) may select one or more beams (e.g., second beams) as new candidate beams.

A WTRU (e.g., having determined/selected a first type of BFR procedure) may transmit one or more UL signals in a UL resource that may be associated with one or more selected new candidate beams (e.g., selected second beams) or may be configured for beam failure recovery. The one or more UL signals may be one or more of the following: PRACH, PUCCH (e.g., including scheduling request (SR)), MAC-CE, and/or PUSCH.

A WTRU (e.g., having determined/selected a first type of BFR procedure) may receive a confirmation PDCCH (e.g., in a CORESET/search space configured for BFR). The PDCCH may be a WTRU specific DCI or a group DCI. The PDCCH may be a DCI format for scheduling one or more shared channels. A monitoring window and/or a counter and a threshold may be used.

In an example using a monitoring window, the WTRU may detect the confirmation PDCCH within the monitoring window. The WTRU may (e.g., if the WTRU does not detect the confirmation PDCCH transmitted by the gNB within the monitoring window) support one or more of following: a contention based RACH procedure; and/or a retransmission of the one or more UL signals (e.g., with increased Tx power).

In an example of using a counter and a threshold, the WTRU may detect the confirmation PDCCH based on a counter and a threshold. The WTRU may increase the counter, for example, if the WTRU fails to select new candidate beams. The WTRU may continue the detection of the confirmation PDCCH, for example, if the counter is less than (or equal to) the threshold. The WTRU may (e.g., if the WTRU does not select new candidate beams and/or the WTRU does not detect the set of second beams transmitted by the gNB before the counter exceeds the threshold) support one or more of following: a contention based RACH procedure; and/or a retransmission of the one or more UL signals (e.g., with increased Tx power).

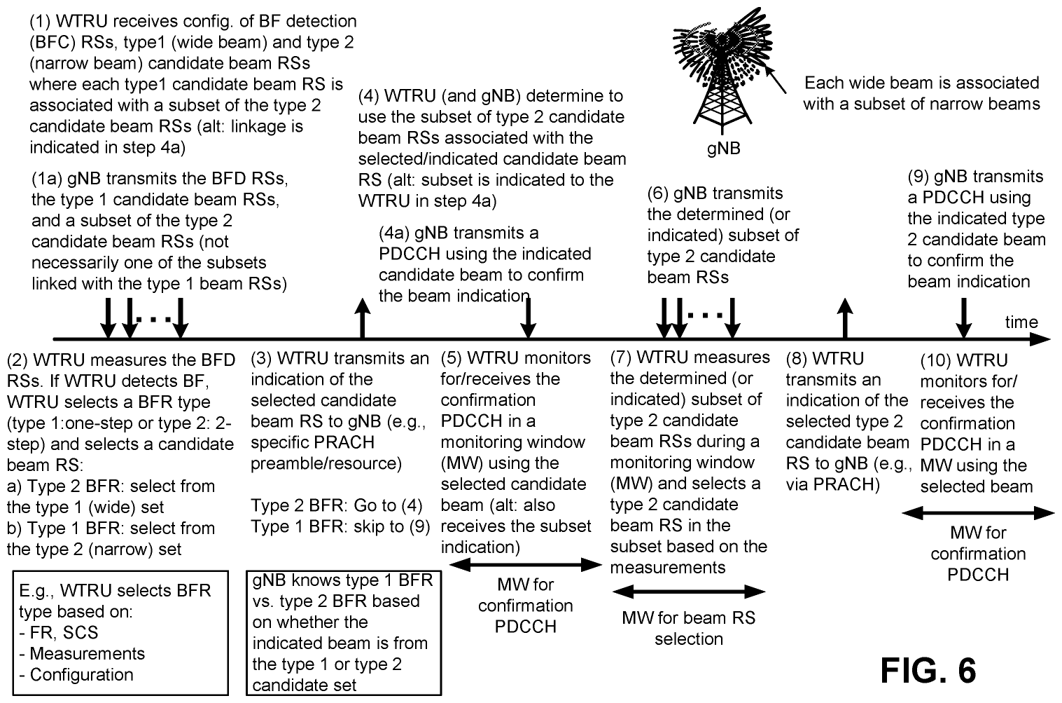

FIG. 6 illustrates an example involving two-step beam failure recovery.

A WTRU may receive configuration information indicating candidate beam reference signals (RSs) of a first type (wide beam pattern or type 1) and candidate beam RSs of a second type (narrow beam pattern or type 2). The WTRU may detect a beam failure and determine a beam failure recovery (BFR) type. The WTRU may determine the BFR type as one of a one-step BFR type (type 1 BFR) or the two-step BFR type (type 2 BFR). Based on the determined BFR type being a two-step BFR type, the WTRU may do the following. The WTRU may select, and transmit an indication of, a candidate beam RS from the candidate beam RSs of the first type. The WTRU may determine a subset of the second type candidate beam RSs based on the selected candidate beam RS. The WTRU may perform measurements on the subset of the second type candidate beam RSs during a first monitoring window. The WTRU may select, and transmit an indication of, a second type candidate beam RS from the subset based on the measurements.

At 1a, the gNB may transmit the BFD RSs, the first type candidate beam RSs, and a subset of the second type candidate beam RSs (e.g., which may not be a subset linked with the first type beam RSs).

In examples, a WTRU may determine/select a second type of BFR procedure (e.g., a two-step beam failure recovery procedure). The BFR type may be determined based on a frequency range (FR), a sub-carrier spacing (SCS), a measurement, and/or a configuration.

The WTRU may determine the subset of the second type candidate beam RSs based on a configured association with the selected candidate beam RS of the first type or by receiving an indication in a PDCCH transmission.

The WTRU may support one or more of the following procedures, e.g., for the second type of BFR procedure.

At 2, the WTRU may measure the BFD RSs. If the WTRU detects beam failure, the WTRU may determine a BFR type (e.g., type 1: one-step, or type 2:2-step) and select a candidate beam RS. The WTRU may determine the BFR type as one of a one-step BFR type or the two-step BFR type. Detecting a beam failure may be based on measurements of beam failure detection reference signals (BFD RSs) corresponding to the beam failure. The WTRU may determine a set of BFD parameters based on the type of BFD RSs, wherein the set of BFD parameters comprises one or more timers, event counters, or thresholds. The WTRU may determine a beam failure based on the parameters.

For a type 2 BFR, a candidate beam RS may be selected from the type 1 (e.g., wide) set. For type 1 BFR, a candidate beam may be selected from the type 2 (e.g., narrow) set. The candidate beam reference signals of the first type may be associated with wide beams, and the candidate beam reference signals of the second type may be associated with narrow beams. The WTRU may transmit an indication of the selected candidate beam RS using any of a Physical Random Access Channel (PRACH) preamble or resource.

The WTRU may select a BFR type based on: FR, SCS; measurements; and/or a configuration. The WTRU (e.g., having determined/selected a second type of BFR procedure) may select one or more first beams as new candidate beams. The WTRU (e.g., having determined/selected a second type of BFR procedure) may transmit one or more UL signals in a UL resource that may be associated with one or more selected new candidate beams (e.g., selected first beams) or may be configured for beam failure recovery. The one or more UL signals may be one or more of the following: PRACH, PUCCH (e.g., including scheduling request (SR)), MAC-CE, and/or PUSCH. For example, at 3, the WTRU may transmit an indication of the selected candidate beam RS to the gNB (e.g., a PRACH preamble/resource).

The WTRU (e.g., having determined/selected a second type of BFR procedure) may receive a confirmation PDCCH (e.g., in a CORESET/search space configured for BFR). At 4, the WTRU and gNB may determine to use the subset of type 2 candidate beam RSs associated with the selected/indicated candidate beam RS. Alternatively, at 4a, a WTRU may receive indication of the subset of type 2 candidate beam RSs via PDCCH. At 4a, a gNB may transmit a PDCCH using the indicated candidate beam to confirm the beam indication.

The PDCCH may be a WTRU specific DCI or a group DCI. The DCI may indicate one or more RS resources/resource sets that the WTRU may measure, e.g., using second beams associated with the selected first beams for beam failure recovery. The PDCCH may be a specific DCI format for the confirmation and/or the indication of the one or more RS resources/resource sets. One or more of the following may be used for WTRU specific confirmation: WTRU specific PDCCH configurations; DCI formats; and/or CRC scrambling with WTRU specific RNTI (e.g., C-RNTI). A monitoring window and/or a counter and a threshold may be used.

At 5, the WTRU may monitor for/receive the confirmation PDCCH in a monitoring window (e.g., a second monitoring window) using the selected candidate beam. The WTRU may receive the PDCCH transmission in the second monitoring window using the selected candidate beam RS, and the PDCCH transmission may include an indication of a confirmation. The WTRU may receive the subset of type 2 candidate beam RSs indication, and the monitoring window may be for a confirmation PDCCH. In an example of using a monitoring window, a WTRU may detect the confirmation PDCCH within the monitoring window. The WTRU may (e.g., if the WTRU does not detect the confirmation PDCCH transmitted by the gNB within the monitoring window) support one or more of following: a contention based RACH procedure; and/or a retransmission of the one or more UL signals (e.g., with increased Tx power).

In an example of using a counter and a threshold, a WTRU may detect the confirmation PDCCH based on a counter and a threshold. The WTRU may increase the counter, for example, if the WTRU fails to select new candidate beams. The WTRU may continue the detection of the confirmation PDCCH, for example, if the counter is less than (or equal to) the threshold. The WTRU may (e.g., if the WTRU does not select new candidate beams and/or the WTRU does not detect the set of second beams transmitted by the gNB before the counter exceeds the threshold) support one or more of following: a contention based RACH procedure; and/or a retransmission of the one or more UL signals (e.g., with increased Tx power).

At 6, the gNB may transmit the determined (or indicated) subset of type 2 candidate beam RSs. The WTRU may perform measurements of the determined subset of the second type candidate beam RSs during a monitoring window. The WTRU may select a second type candidate beam RS from the subset of the second type candidate beam RSs based on the measurements (e.g., beam with the highest L1-RSRP). The WTRU may transmit an indication of the selected second type candidate beam RS using a PRACH transmission.

The WTRU (e.g., having determined/selected a second type of BFR procedure) may receive a set of second beams associated with the reported first beams (e.g., based on one or more of the following) or a set of second beams indicated by the gNB in step 4a.

The WTRU may receive a set of second beams in the RS resources/resource sets associated with the reported first beams. The association may be predefined or configured/indicated by a gNB.

The WTRU may receive a set of second beams in the RS resources/resource sets indicated by the confirmation PDCCH.

The WTRU may measure/monitor the set of second beams based on one or more of following: a monitoring window; and/or a counter and a threshold.

At 7, the WTRU may measure the determined (or indicated) subset of type 2 candidate beam RSs during a monitoring window and select a type 2 candidate beam RS in the subset based on the measurement (e.g., beam with the highest L1-RSRP). The monitoring window may be for beam RS selection. In an example of measuring/monitoring the set of second beams based on a monitoring window, the WTRU may measure and/or monitor the set of second beams within the monitoring window (e.g., for beam RS selection). The WTRU may (e.g., if the WTRU does not select new candidate beams and/or the WTRU does not detect the set of second beams transmitted by the gNB within the monitoring window) support one or more of following: a contention based RACH procedure; and/or a retransmission of the one or more UL signals (e.g., with increased Tx power).

In an example of measuring/monitoring the set of second beams based on a counter and a threshold, the WTRU may measure and monitor the set of second beams based on a counter and a threshold. The WTRU may increase a counter, for example, if the WTRU fails to select new candidate beams. The WTRU may continue measurement and monitoring, for example, if the counter is less than (e.g., or equal to) the threshold. The WTRU may (e.g., if the WTRU does not select new candidate beams and/or the WTRU does not detect the set of second beams transmitted by the gNB before the counter exceeds the threshold) support one or more of following: a contention based RACH procedure; and/or a retransmission of the one or more UL signals (e.g., with increased Tx power).

The WTRU may select one or more second beams of the set of second beams as new candidate beams, for example, based on a quality of the set of second beams. At 8, the WTRU may transmit an indication of the selected type 2 candidate beam RS to gNB (e.g., via PRACH).

In examples, the WTRU may select K (e.g., best) beams based on the quality (e.g., L1-RSRP). K may be preconfigured by RRC and/or MAC-CE and or DCI.

The WTRU may transmit one or more UL signals associated with the one or more second beams. The one or more UL signals may be one or more of the following: PRACH, PUCCH (e.g., including scheduling request (SR)), MAC-CE, and/or PUSCH. The UL signals may be transmitted in an associated UL resource with the one or more second beams. The UL signals may include beam indexes of the one or more second beams.

At 9, the gNB may transmit a PDCCH using the indicated type 2 candidate beam to confirm the beam indication. The WTRU may receive a PDCCH confirming the reception of one or more UL signals indicating the new candidate beams, for example, via a configure CORESET/search spaced (e.g., for BFR procedure). A monitoring window and/or a counter and a threshold may be used.

At 10, the WTRU may monitor for/receive the confirmation PDCCH in a monitoring window using the selected beam. In an example of using a monitoring window, a WTRU may detect the confirmation PDCCH within the monitoring window. The WTRU may (e.g., if the WTRU does not detect the confirmation PDCCH transmitted by the gNB within the monitoring window) support one or more of the following: a contention based RACH procedure; and/or a retransmission of the one or more UL signals (e.g., with increased Tx power).

In an example of using a counter and a threshold, a WTRU may detect the confirmation PDCCH based on a counter and a threshold. The WTRU may increase the counter, for example, if the WTRU fails to select new candidate beams. The WTRU may continue the detection of the confirmation PDCCH, for example, if the counter is less than (e.g., or equal to) the threshold. The WTRU may (e.g., if the WTRU does not select new candidate beams and/or the WTRU does not detect the set of second beams transmitted by the gNB before the counter exceeds the threshold) support one or more of the following: a contention based RACH procedure; and/or a retransmission of the one or more UL signals (e.g., with increased Tx power).

Beam failure recovery may be implemented with multiple beam failure recovery reference signal sets.

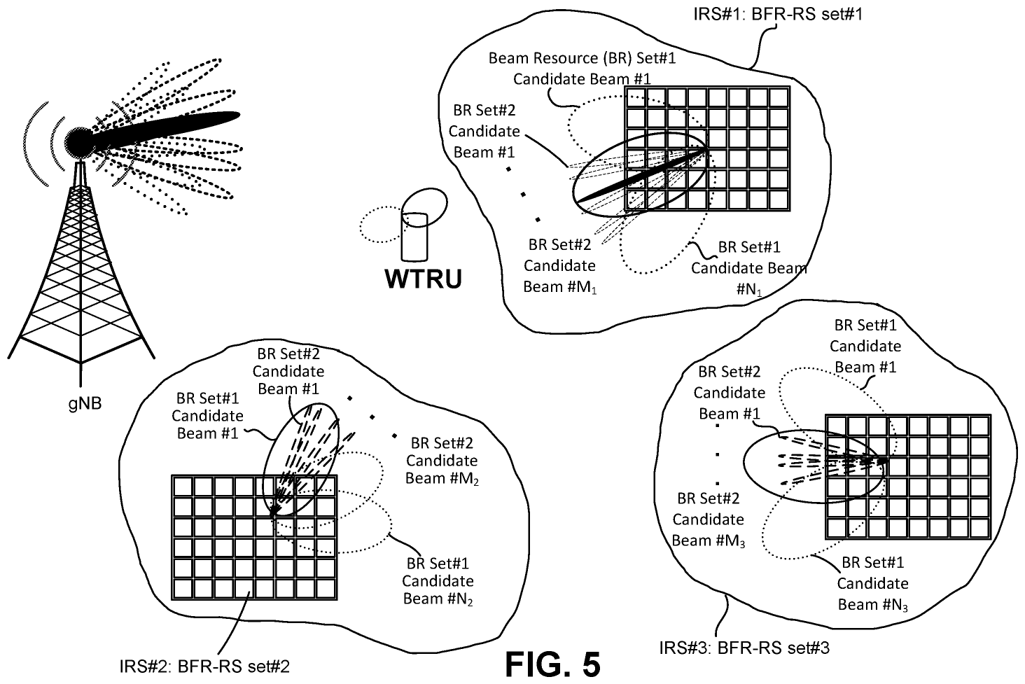

FIG. 5 illustrates an example configuration of multiple BFR RS sets for new beam determination through BFR. The WTRU may receive configuration information for multiple beam failure recovery reference signal (BFR-RS) sets, and the BFR-RS set may include resources and configurations associated with a beam failure recovery. The WTRU may select one or more BFR-RS sets for beam failure recovery based on any of a priority or a beam quality measurement. The WTRU may determine a second type candidate beam using a highest priority BFR-RS from the selected one or more BFR-RS sets or by attempting to find a new candidate beam using each selected BFR-RS set sequentially based on priority.

A WTRU may be configured with multiple beam failure recovery reference signal (BFR-RS) sets. A BFR-RS set may include (e.g., all) resources and configurations that may be used to (e.g., independently) process beam failure recovery by a WTRU. In examples, a BFR-RS set may include one or more of the following: resources for beam failure detection, a set of a first type of candidate beams (e.g., first candidate beam set), one or more sets of a second type of candidate beams (e.g., second candidate beam sets), one or more sets of UL resources for a beam failure indication, a CORESET for compact PDCCH transmission (e.g., to configure beam sweeping using the second candidate beam sets), and/or a BFR CORESET (e.g., for confirmation PDCCH transmission once a new candidate beam has been selected from a second candidate beam set). A subset of UL resources for a beam failure indication may be associated with a first candidate beam set and/or another subset of beam failure resources may be associated with the second candidate beam set.

A BFR-RS set may be associated with one or more (e.g., a combination of) network nodes (e.g., IRSs, relays, access points, gNBs, and/or the like), for example, as shown in FIG. 5. A BFR-RS set may be identified by an index. An index may be, for example, a dedicated index per BFR-RS set or an index of the network node the BFR-RS set is associated with, e.g., if a BFR-RS set corresponds to one network node.

BFR-RS set monitoring may be activated. A WTRU may select a subset of BFR-RS sets that the WTRU is configured with to be active. The WTRU may monitor resources that may be used for beam failure recovery of active BFR-RS sets. One or more of the following may apply/be performed.

A WTRU may be configured (e.g., by RRC signaling) to monitor one or more active BFR-RS sets.

A WTRU may be configured (e.g., by RRC signaling) with one or more BFR-RS sets. The WTRU may determine the subset of BFR-RS sets to be monitored, for example, based on the downlink (DL) signaling by the gNB. A WTRU may activate monitoring for a subset of BFR-RS sets, for example, based on a DCI or a MAC-CE indication. A WTRU may receive a DCI or a MAC-CE carrying a set of bits with a bit indicating ‘1’ or ‘0’, for example, where ‘1’ represents a BFR-RS set to be activated and ‘0’ represents a BFR-RS set to be deactivated.

A WTRU may activate monitoring for one or more BFR-RS sets to be monitored based on beam quality measurements of one or more first and/or second beams. A beam quality measurement may include, for example, one or more of the following: an L1-RSRP, an L1-SINR, a CQI, radio link quality (e.g., hypothetical BLER of DL/UL physical channel). In examples, a WTRU or set of WTRUs may monitor an RS resource set, which may include all or part of the first beam resources configured as a first type of candidate beams of BFR-RS sets that the WTRU may be configured with. The WTRU may perform one or more beam quality measurements of a configured RS resource set. The WTRU may provide (e.g., feedback) the beam measurements to the gNB. The WTRU may (e.g., subsequently) activate monitoring for a selected set of BFR-RS sets based on one or more of the following.

The WTRU may activate monitoring for BFR-RS sets out of the configured sets of BFR-RS sets with the (e.g., best) first type of candidate beam compared to (e.g., exceeding) a (e.g., configured) threshold.

The WTRU may activate monitoring based on an order of BFR-RS sets according to the beam quality of the (e.g., best) first type of candidate beam of a BFR-RS set. A (e.g., preconfigured) number of BFR-RS sets may be selected to be monitored out of the ordered set of BFR-RS sets.

The WTRU may activate monitoring for a (e.g., preconfigured) number of BFR-RS sets based on the number of first type of candidate beams of a BFR-RS set compared to (e.g., exceeding) a (e.g., preconfigured) threshold. In an example scenario, a WTRU may be configured with three (3) BFR-RS sets (e.g., #1, #2, and #3). The number of BFR-RS sets to be monitored may be two (2). The WTRU may determine (e.g., through beam monitoring) that, BFR-RS set #1, BFR-RS set #2, and BFR-RS set #3 have, respectively, three (3), two (2), and one (1) first type of candidate beams that exceed a (e.g., predefined) threshold. The WTRU may (e.g., in this example scenario) activate monitoring BFR-RS set #1 and BFR-RS set #2.

An activated BFR-RS set for a WTRU may assigned a priority. A WTRU may determine the priority of a BFR-RS set, for example, by one or more of the following: RRC signaling; a MAC-CE indication; a DCI indication; beam quality measurements of the first type of candidate beams associated with the active BFR-RS sets; the BFR-RS set associated with the network node currently serving the WTRU; the number of first type of candidate beam resources configured for a BFR RS set; a BFR RS set index; or applicability of a maximum permitted exposure (MPE) or a spectrum absorption ratio (SAR) active issue for a WTRU panel that corresponds to a BFR-RS set.

In an example of determining the priority of a BFR-RS set based on beam quality measurements of the first type of candidate beams associate with the active BFR-RS sets, a WTRU may perform a beam quality measurement of a first type of candidate beams of BFR-RS sets. A priority may be assigned for a BFR-RS set, for example, based on the measurements.

In examples, the WTRU may assign a priority for each BFR-RS set based on a determination of the beam quality of the first type of candidate beam of a BFR-RS set. In examples, a WTRU may assign the priority based on the best-first type of candidate beam in a BFR-RS set, e.g., the BFR-RS set with the highest quality best-first type of candidate beam may be assigned the top priority. The BFR-RS set with the second highest quality best-first type of candidate beam may be assigned the next priority level, and so on until (e.g., all) the active BFR-RS sets are assigned a priority. In examples, a WTRU may assign priority based on the worst-first type of candidate beam of a BFR-RS set, e.g., the BFR-set with the highest quality worst-first type of candidate beam may be assigned the top priority. The BFR-RS set with the second highest quality worst-first type of candidate beam may be assigned the next priority level, and so on until (e.g., all) the active BFR-RS sets are assigned with a priority.

In examples, the WTRU may assign priority for activated BFR-RS sets based on the number of first type of candidate beams compared to (e.g., exceeding) a (e.g., preconfigured) threshold.

In an example of determining the priority of a BFR-RS set based on the BFR-RS set associated with the network node currently serving the WTRU, a WTRU may assign the highest priority to the BFR-RS set associate with the network node currently serving the WTRU. The remaining BFR-RS sets may assign priority based on one or more (e.g., a combination) of the other examples described herein.

In an example of determining the priority of a BFR-RS set based on the number of a first type of candidate beam resources configured for a BFR RS set, a WTRU may assign a higher priority to a BFR-RS set with the highest number of configured first type of candidate beams. A WTRU may assign the second highest priority to the BFR-RS set with the second largest number of first type of candidate beam resources. In an example with two BFR-RS sets configured with a similar number of first type of candidate beams, the BFR-RS set with the lower/higher index may be assigned the higher priority. The process of assigning priorities may continue until (e.g., all) the active BFR-RS sets are assigned a priority.

In an example of determining the priority of a BFR-RS set based on a BFR RS set index, a WTRU may assign a highest priority to the BFR-RS set with the lowest or highest index. A WTRU may assign the next highest priority to the active BFR-RS set with the second lowest or highest index, and so on until (e.g., all) the active BFR-RS sets are assigned a priority.

In an example of determining the priority of a BFR-RS set based on the applicability of MPE or SAR active issues for a WTRU panel that corresponds to a BFR-RS set, a WTRU configured with two BFR-RS sets may assign the BFR-RS set affected by an MPE or SAR issue with a different (e.g., lower) priority compared to a priority assigned to the other BFR-RS set not affected by MPE or SAR.

Beam failure recovery may be implemented using one or more active BFR RS sets. A WTRU may choose one or more BFR-RS sets to perform beam failure recovery, for example, if the WTRU activates monitoring for more than one BFR-RS set. The WTRU may choose one or more BFR-RS sets to perform beam failure recovery based on one or more (e.g., a combination) of the following: a priority of a BFR-RS set; a beam quality measurement of the (e.g., best) first type of candidate beams; an index of a BFR-RS set/index of the network node associated with a BFR-RS set.

In an example of choosing one or more BFR-RS sets to perform beam failure recovery based on a priority of a BFR-RS set, a WTRU may select the BFR-RS set with the highest priority to perform beam failure recovery. In examples, the WTRU may order BFR-RS sets based on their priority and/or select a (e.g., configured) number of high priority BFR-RS sets to perform beam failure recovery.

In an example of choosing one or more BFR-RS sets to perform beam failure recovery based on a beam quality measurement of a (e.g., best) first type of candidate beams, a WTRU may (e.g., be configured to) monitor an RS resource set, which may include multiple first type of beam resources configured as a first type of candidate beams for more than one BFR-RS set. In an example, a BFR-RS set with the highest quality first type of candidate beam may be selected to find a new beam through the beam failure recovery procedure. In examples, the WTRU may select (e.g., all) the BFR-RS sets with the highest quality first type of candidate beam resources that meet (e.g., satisfy) a (e.g., preconfigured) threshold beam quality.

In an example of choosing one or more BFR-RS sets to perform beam failure recovery based on an index of a BFR-RS set/index of the network node associated with a BFR-RS set, a WTRU may (e.g., be configured to) select the activated BFR-RS set with the lowest index for new beam identification through beam failure recovery.

A WTRU may use the activated/selected BFR-RS set to choose one or more new candidate beams (e.g., one or more second beams), for example, if a WTRU (e.g., only) activates monitoring a (e.g., one) BFR-RS set or selects a (e.g., one) BFR-RS set to perform beam failure recovery. The WTRU may use the activated/selected BFR-RS set to choose one or more new candidate beams (e.g., one or more second beams), for example, as described herein.

A WTRU may (e.g., determine to) use a first type of BFR procedure or a second type of BFR procedure, for example, based on one or more following: an explicit/implicit indication from a gNB; a type of selected resources for new candidate beams; the number of beam failure recovery procures N initiated or completed within a preconfigured time interval T; a procedure selection timer; a measurement or metric related to mobility aspects; a frequency range; an SCS; a number of configured TCI states or a number of SSBs detected by the WTRU for the serving cell; a beamwidth supported by IRS/relates/access point/gNBs for data and control channel; and/or remaining battery power.

A WTRU may determine a new candidate beam, for example, if a second type of beam failure recovery procedure is selected. The WTRU may determine a new candidate beam, for example, based on one or more of the following: the WTRU may select one or more first beams as new candidate beams; the WTRU may transmit one or more UL signals in a UL resource associated with one or more new candidate beams selected; the WTRU may receive a conformation PDCCH, e.g., in response to a UL signal transmitted indicating the selected new candidate beam (e.g., WTRU may declare that the beam failure recovery through the selected BFR-RS set to be a failure, for example, if the WTRU fails to detect a confirmation PDCCH in response to a UL signal associated with one or more new candidate beams); the WTRU may receive a set of second beams associated with the reported first beams; the WTRU may select one or more second beams of the set of second beams as new candidate beams; the WTRU may transmit one or more UL signals associated with the one or more second beams selected; the WTRU may receive a PDCCH confirming the reception of one or more UL signal associated with one or more second beams; and/or the WTRU may retransmit UL signal associated with one or more second beams selected (e.g., with increased Tx power) and monitor for PDCCH confirmation, for example, if the WTRU does not receive a PDCCH confirmation (e.g., the WTRU may declare that the beam failure recovery through the selected BFR-RS set is a failure, for example, if the WTRU fails to detect a confirmation PDCCH in response to UL signal associated with one or more second beams).

A WTRU may determine a new beam (e.g., as described herein), for example, if the first type of beam failure recovery procedure is selected. A WTRU may perform one or more of the following to determine a new beam (e.g., if the first type of beam failure recovery procedure is selected): the WTRU may select one or more second beams as new candidate beams; the WTRU may transmit one or more UL signals in a UL resource associated with one or more second beams; the WTRU may receive a PDCCH confirming the reception of one or more UL signals associated with one or more second beams; and/or the WTRU may retransmit a UL signal associated with one or more second beams selected (e.g., with increased Tx power) and monitor for PDCCH confirmation, for example, if the WTRU does not receive a PDCCH confirmation (e.g., the WTRU may declare that the beam failure recovery through the selected BFR-RS set is a failure, for example, if the WTRU fails to detect a confirmation PDCCH in response to UL signal associated with one or more second beams).

The WTRU may perform BFR using the highest priority BFR-RS set first, for example, if the WTRU selects more than one BFR-RS set. The WTRU may perform BFR using the BFR-RS set next in the priority order, if, for example, the WTRU determines that an attempt failed. The process may continue until a new beam is successfully identified using a BFR-RS set or until (e.g., all) the BFR-RS sets are attempted. The WTRU may (e.g., based on the type of BFR) determine unsuccessful BFR attempts with a BFR-RS set, for example, by using one or more examples described herein in reference to a WTRU attempting BFR using a (e.g., one) BFR-RS set. The WTRU may declare an RLF, for example, if the WTRU determines that all the BFR-RS sets have been attempted without successfully finding a new candidate beam.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-35. (canceled)

36. A wireless transmit receive unit (WTRU) comprising:
a processor configured to:
receive configuration information indicating a first set of candidate beam reference signals (RSs) of a first type, a second set of candidate beam RSs of a second type, and one or more additional sets of candidate beam RSs of the second type, wherein each of the one or more additional sets of candidate beam RSs of the second type is associated with a respective RS of the first set of candidate beam RSs;
receive the first set of candidate beam RSs of the first type and the second set of candidate beam RSs of the second type, wherein the first set of candidate beam RSs and the second set of candidate beam RSs are received during a first monitoring window;
detect a beam failure and determine a beam failure recovery (BFR) type; and
based on the determined BFR type being a two-step BFR type:
transmit an indication of a candidate beam RS that is selected from the first set of candidate beam RSs of the first type;
receive a first additional set of candidate beam RSs of the second type, wherein the first additional set is one of the one or more additional sets of candidate beam RSs of the second type;
perform measurements on the first additional set of candidate beam RSs of the second type during a second monitoring window; and
transmit an indication of a candidate beam RS of the second type that is selected from the first additional set based on the measurements.

37. The WTRU of claim 36, wherein the candidate beam reference signals of the first type are associated with wide beams, and the candidate beam reference signals of the second type are associated with narrow beams.

38. The WTRU of claim 36, wherein the processor is further configured to determine whether the BFR type as one of a one-step BFR type or the two-step BFR type.

39. The WTRU of claim 36, wherein the BFR type is determined based on one or more of the following: a frequency range (FR), a sub-carrier spacing (SCS), a measurement, or a configuration.

40. The WTRU of claim 36, wherein the beam failure is detected based on measurements of beam failure detection reference signals (BFD RSs) corresponding to the beam failure.

41. The WTRU of claim 40, wherein the processor is further configured to determine a set of beam failure detection (BFD) parameters based on a type of the BFD RSs, wherein the set of BFD parameters comprises one or more timers, event counters, or thresholds, and wherein the beam failure is detected based on the parameters.

42. The WTRU of claim 36, wherein the processor is further configured to transmit the indication of the candidate beam RS of the second type that is selected from the first additional set using any of a physical random access channel (PRACH) preamble or resource.

43. The WTRU of claim 36, wherein the processor is further configured to:
monitor, in a third monitoring window, for a physical downlink control channel (PDCCH) transmission using the candidate beam RS of the second type that is selected from the first additional set;
receive the PDCCH transmission in the third monitoring window using the candidate beam RS of the second type that is selected from the first additional set, wherein the PDCCH transmission includes an indication of a confirmation.

44. A method for a wireless transmit receive unit (WTRU), the method comprising:
receive configuration information indicating a first set of candidate beam reference signals (RSs) of a first type, a second set of candidate beam RSs of a second type, and one or more additional sets of candidate beam RSs of the second type, wherein each of the one or more additional sets of candidate beam RSs of the second type is associated with a respective RS of the first set of candidate beam RSs;
receive the first set of candidate beam RSs of the first type and the second set of candidate beam RSs of the second type, wherein the first set of candidate beam RSs and the second set of candidate beam RSs are received during a first monitoring window;
detect a beam failure and determine a beam failure recovery (BFR) type; and
based on the determined BFR type being a two-step BFR type:
transmit an indication of a candidate beam RS that is selected from the first set of candidate beam RSs of the first type;
receive a first additional set of candidate beam RSs of the second type, wherein the first additional set is one of the one or more additional sets of candidate beam RSs of the second type;
perform measurements on the first additional set of candidate beam RSs of the second type during a second monitoring window; and
transmit an indication of a candidate beam RS of the second type that is selected from the first additional set based on the measurements.

45. The method of claim 44, wherein the candidate beam reference signals of the first type are associated with wide beams, and the candidate beam reference signals of the second type are associated with narrow beams.

46. The method of claim 44, wherein the method further comprises determining whether the BFR type as one of a one-step BFR type or the two-step BFR type.

47. The method of claim 44, wherein the BFR type is determined based on one or more of the following: a frequency range (FR), a sub-carrier spacing (SCS), a measurement, or a configuration.

48. The method of claim 44, wherein the beam failure is detected based on measurements of beam failure detection reference signals (BFD RSs) corresponding to the beam failure.

49. The method of claim 48, wherein the method further comprises determining a set of beam failure detection (BFD) parameters based on a type of the BFD RSs, wherein the set of BFD parameters comprises one or more timers, event counters, or thresholds, and wherein the beam failure is detected based on the parameters.

50. The method of claim 44, wherein the method further comprises transmitting the indication of the candidate beam RS of the second type that is selected from the first additional set using any of a physical random access channel (PRACH) preamble or resource.
